(19) United States
(12) Patent Application Publication
(10) Pub. No.: US 2005/0190668 A1
(43) Pub. Date: Sep. 1, 2005

(54) Optical recording/reproduction apparatus having mechanism for correcting spherical aberration

(75) Inventor: Katsuya Yamazaki, Kawasaki-Shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/065,094

(22) Filed: Feb. 25, 2005

(30) Foreign Application Priority Data
Mar. 1, 2004 (JP) 2004-056269

(51) Int. Cl. G11B 7/00

(52) U.S. Cl. 369/44.32; 369/53.25; 369/112.01

(57) ABSTRACT

For preventing incorrect operations of recording and reproduction of information in accordance with a spherical aberration occurred in an objective lens, the optical recording/reproduction apparatus of the present invention includes a correction mechanism for correcting the spherical aberration of a light beam condensed on an optical recording/reproduction medium, a detection circuit for detecting the amount of the spherical aberration, a discrimination circuit for discriminating whether the detected spherical aberration amount exceeds a predetermined amount, and a circuit for stopping the operation of recording or reproduction of the information when the determination circuit discriminates that the spherical aberration amount exceeds the predetermined amount.

### BACKGROUND OF THE INVENTION

1. Field of the Invention

The present invention relates to an optical information recording/reproduction apparatus such as an optical disc and an optical card, particularly to an optical recording/reproduction apparatus for high-density recording.

2. Related Background Art

An optical disc such as a CD (Compact Disc) or DVD (Digital Versatile Disc) and an optical information recording/reproduction apparatus for handling the optical disc are known as information recording/reproduction apparatuses for music and video data.

Because the data quantity to be handled is recently increased, the optical resolution for recording and reproducing the optical disc is improved and a capacity is increased by decreasing the wavelength λ of a semiconductor laser which is a light source for recording and reproducing the optical disc or by increasing the numerical aperture NA of an objective lens for condensing a light beam emitted from the semiconductor laser into the optical disc.

For example, in the case of the wavelength (λ=780 nm) and numerical aperture (NA=0.45) of a general CD, the spot diameter condensed on an optical disc is approx. 1.7 μm and in the case of the wavelength (λ=660 nm) and numerical aperture (NA=0.6) of a DVD standardized by making the capacity larger than that of the CD, the spot diameter condensed on the optical disc is approx. 1.1 μm.

Thus, in the case of the DVD, the recording density is increased up to about 2.5 times the recording density of a CD by decreasing the wavelength of a light source and increasing the numerical aperture of an objective lens. Moreover, by introducing an advanced signal processing technique into a reproduced signal reproduced from the optical disc, the storage capacity of a 120-mm DVD realizes 4.7 GB which is seven times the storage capacity of 640 MB of a 120-mm CD. Furthermore, as another standard, a BD (Blue-ray Disc) using a wavelength λ of 405 nm and a numerical aperture NA of 0.85 is also proposed.

Furthermore, a double-sided optical disc having a recording/reproduction layer at both sides of the disc and a multilayer disc obtained by stacking a plurality of recording/reproduction layers on the same side of the disc are proposed and the capacities are further increased.

FIG. 9 is an illustration showing a typical configuration of an optical recording/reproduction apparatus using the above optical discs.

When reproducing information from an optical disc 1 and recording information on the optical disc 1, the optical disc 1 is rotated at a predetermined rotating speed by a spindle motor 2 for supporting the optical disc 1.

Thereafter, a light beam is emitted from a light source 3 such as a semiconductor laser, the light beam is condensed on the optical disc 1 by an objective lens 4, the objective lens 4 is driven by a tracking actuator and a focus actuator (not shown) for supporting the objective lens 4, and thereby the tracking servo and focus servo of the light beam condensed on the optical disc 1 are applied to perform information recording on the optical disc 1 and information reproduction from the optical disc 1.

FIGS. 10A, 10B and 10C are illustrations showing detection states of a tracking error signal by a half-split sensor.

The push-pull system shown in FIGS. 10A to 10C is widely known as the tracking servo of the optical disc 1. In the case of the push-pull system, a light beam reflected from the optical disc 1 is detected by a half-split sensor 5 provided for half-splitting a light beam reflected from the optical disc 1 in parallel with a track formed on the optical disc 1. The state shown in FIG. 10A is a state in which the light beam is more accurately condensed on the objective lens 4 at the center of the track formed on the optical disc 1. In this case, the light beam reflected from the optical disc 1 enters each region serving as a light-receiving element of the half-split sensor 5 at almost equal intensity, and outputs Ta₁ and Ta₂ corresponding to the regions become an equal state. The state shown in FIG. 10B is a state in which the light beam is condensed by being polarized in one direction from the center of a track formed on the optical disc 1. FIG. 10B shows a case in which the light beam reflected from the optical disc 1 is an unbalanced state of Ta₁<Ta₂. Similarly, the state shown in FIG. 10C is a state in which a light beam is condensed by being polarized in the other direction from the center of a track formed on the optical disc 1. FIG. 10C shows a case in which the light beam reflected from the optical disc 1 is an unbalanced state of Ta₁>Ta₂.

Thus, the light beam reflected from the optical disc 1 is detected by the half-split sensor 5 provided for half-splitting the light beam reflected from the optical disc 1 in parallel with a track, the difference signal (tracking error signal) T_{E} between outputs Ta₁ and Ta₂ of the half-split sensor 5 is obtained by a difference circuit 6 and the objective lens 4 is driven by a tacking actuator (not shown) so that an error of the tracking error signal disappears and thereby a light beam can be condensed to any track center set on the optical disc 1.

FIGS. 11A to 11C are illustrations showing detection states of a focus error signal by a four-split sensor.

The astigmatism system shown in FIGS. 11A to 11C is widely known as the focus servo of the optical disc 1. The astigmatism system is used to detect the light beam reflected from the optical disc 1 by a four-split sensor 7 provided for four-splitting the light beam centering around the optical axis of the light beam. The state shown in FIG. 11A is a state in which a light beam is accurately condensed by the objective lens 4 on a recording/reproduction layer formed on the optical disc 1. In this case, the light beam reflected from the optical disc 1 enters each region serving as a light-receiving element of the four-split sensor 7 at almost equal intensity and outputs Fo₁ to Fo₄ corresponding to the regions become an equal state. The state shown in FIG. 11B is a state in which a light beam is condensed while being polarized in one direction from the recording/reproduction layer formed on the optical disc 1. FIG. 11B shows a case in which the sum of opposite angle outputs of the light beam reflected from the optical disc 1 is an unbalanced state of (Fo₁+Fo₃)<(Fo₂+Fo₄) Similarly, the state shown in FIG. 11C is a state in which a light beam is condensed while being polarized in the other direction from the recording/reproduction layer formed on the optical disc 1. FIG. 11C shows a case in which the sum of opposite angle outputs of the light beam reflected from the optical disc 1 is the unbalanced state of (Fo₁+Fo₃)>(Fo₂+Fo₄).

Thus, the light beam reflected from the optical disc 1 is detected by the four-split sensor 7 provided for four-splitting the light beam reflected from the optical disc 1 centering around the optical axis, the sum of opposite angle of outputs Fo₁ to Fo₄ of the four-split sensor is obtained by addition circuits 8 and 9, the difference signal (focus error signal) F_{E} of the sum of opposite angles is obtained by the difference circuit 10, and the objective lens 4 is driven by a focus actuator (not shown) so that an error of the focus error signal disappears, whereby the light beam can be focused on any recording/reproduction layer formed on the optical disc 1.

It is possible to use the half-split sensor 5 for obtaining the tracking error signal and the four-split sensor 7 for obtaining the focus error signal can be used in common. As an example, it is possible to use (Fo₁+Fo₄) of the four-split sensor 7 instead of the Ta₁ signal of the half-split sensor and (Fo₂+Fo₃) instead of the Ta₂ signal.

Detection of the tracking error and focus error is known in Morio Onoue, et al. “Optical Disc Technique”, (Kabushikikaisha) RADIO GIJUTSU SHA (Jul. 20, 1992), pp. 79-98.

In the case of an optical recording/reproduction apparatus, the light-source wavelength (λ) of the semiconductor laser used for an optical disc is decreased, the numerical aperture (NA) of the objective lens is increased and the recording density of the optical disc is remarkably improved by development of many new signal processing techniques.

Typical values of the above-described CD, DVD and BD are shown below.

TABLE 1

| | Light-source | Numerical | | | | |
|---|---|---|---|---|---|---|
| | wavelength | aperture | Spot | Recording | | Capacity |
| | (λ) | (NA) | diameter | capacity | | ratio |
| CD | 780 nm | 0.45 | 1.73 μm | 640 | MB | 1.0 |
| DVD | 660 nm | 0.60 | 1.10 μm | 4.7 | GB | 7.3 |
| BD | 405 nm | 0.85 | 0.48 μm | 27 | GB | 42.2 |

To improve the recording capacity (recording density), when the numerical aperture (NA) of the objective lens is increased, the spherical aberration is increased proportionally to the fourth power of the numerical aperture (NA) of the objective lens. Therefore, it is known that the objective lens becomes weak in thickness of transmission layer of a disc, that is, substrate thickness fluctuation. Moreover, because the coma aberration is also increased inversely proportionally to the third power of the numerical aperture (NA) of the objective lens, it is known that the objective lens becomes weak in the tilt fluctuation of a disc. Therefore, the substrate thickness of a DVD is made smaller than that of a CD, and the substrate thickness of a BD is made smaller than that of the DVD for reducing the influence by the spherical aberration and the coma aberration.

Therefore, in the case of a DVD drive using a disc substrate thickness of 0.6 mm, it is an important problem from the viewpoint of compatibility between a drive and an optical disc to make it possible to perform reproduction of a CD using a substrate thickness of 1.2 mm conventionally used.

Therefore, Japanese Patent Application Laid-Open No. H07-65409 discloses a method for correcting the spherical aberration of an optical disc different in the substrate thickness by inserting a convex lens between a semiconductor laser serving as a light source and an objective lens.

According to Japanese Patent Application Laid-Open No. H07-65409, when designing the objective lens for an optical disc having a substrate thickness of 0.6 mm and reproducing an optical disc having a substrate thickness of 1.2 mm, the convex lens is inserted into an optical path so as to correct the spherical aberration of the objective lens.

Moreover, as another means, it is disclosed to correct a spherical aberration by setting an electric optical element such as a hologram between a semiconductor laser serving as a light source and an objective lens and driving the electric optical element in accordance with a substrate thickness.

However, in the case of the means disclosed in Japanese Patent Application Laid-Open No. H07-65409, when a larger vibration occurs in an apparatus including a pickup, there is a problem that a convex lens for correcting the spherical aberration is shifted from a correct aberration correcting position and correct recording or reproduction cannot be performed. Moreover, when the unevenness of a substrate thickness of a disc transmission layer is local and has a large change width, there are problems that spherical aberration correction cannot follow the change width, whereby information cannot be correctly recorded at the portion and information which must have been recorded cannot be reproduced.

### SUMMARY OF THE INVENTION

The present invention provides an apparatus capable of preventing incorrect recording and reproduction operations by stopping the recording or reproduction operation according to the spherical aberration occurred on the objective lens. Moreover, the present invention provides an apparatus capable of correcting a spherical aberration after stopping the recording and reproduction operations and restarting correct recording or reproducing operation.

A preferred embodiment of the present invention is described below.

An optical recording and reproducing apparatus for condensing a light beam on a recording/reproduction layer of an optical recording/reproduction medium, and recording or reproducing information includes:
a correction mechanism for correcting the spherical aberration of a light beam condensed on the medium;
a detection circuit for detecting the spherical aberration value;
a discrimination circuit for discriminating whether the detected spherical aberration amount exceeds a predetermined amount; and
a circuit for stopping the operation of recording or reproduction of the information when the determination circuit discriminates that the spherical aberration amount exceeds the predetermined amount.

The above-described apparatus may be further include a circuit for correcting the spherical aberration of the light beam by the spherical aberration correcting mechanism after stopping the operation of recording or reproduction of the information, and restarting the operation recording or reproduction of the information.

### BRIEF DESCRIPTION OF THE DRAWINGS

FIG. 1 is an illustration showing a typical configuration of an optical recording/reproduction apparatus according to an embodiment of the present invention;

FIGS. 2A and 2B are illustrations showing detection states of a spherical aberration signal by a half-split sensor;

FIG. 3 is an illustration showing one example of a sensor for using a half-split sensor and a four-split sensor in common;

FIG. 4 is an illustration showing another example of the sensor for using a half-split sensor and a four-split sensor in common;

FIG. 5 is an illustration showing a focus error signal;

FIG. 6 is an illustration showing a tracking error signal;

FIG. 7 is an illustration showing occurrence of a spherical aberration;

FIG. 8 is an illustration showing the level of a spherical-aberration error signal;

FIG. 9 is an illustration showing a typical configuration of an optical recording/reproduction apparatus used for a conventional optical disc;

FIGS. 10A, 10B and 10C are illustrations showing detection states of a tracking error signal by a half-split sensor; and

FIGS. 11A, 11B and 11C are illustrations showing detection states of a focus error signal by a four-split sensor.

### DESCRIPTION OF THE PREFERRED EMBODIMENTS

An embodiment according to the present invention is described below with reference to the drawings.

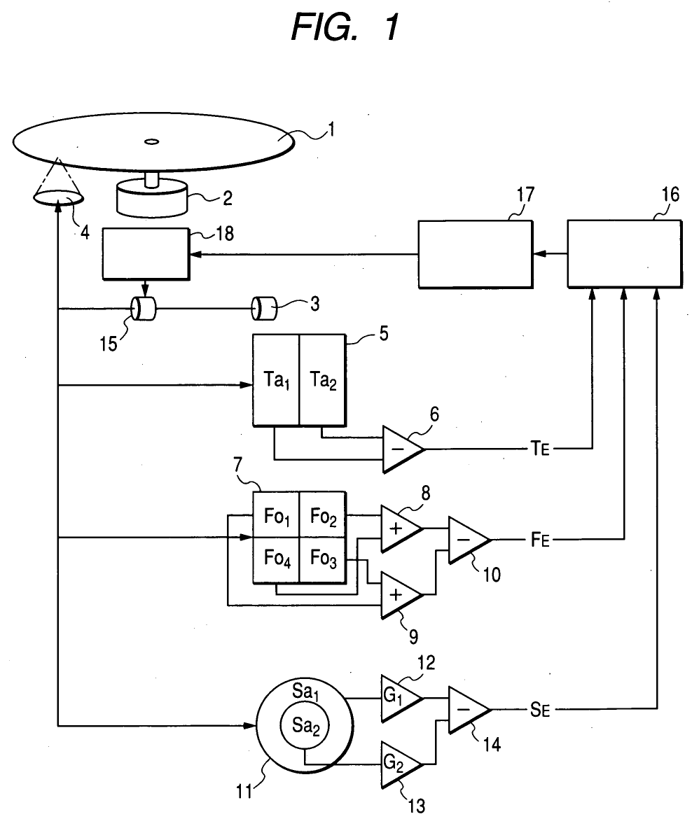

FIG. 1 is an illustration showing a typical configuration of an optical recording/reproduction apparatus according to an embodiment of the present invention.

When reproducing information from the optical disc 1 and recording information on an optical disc 1, the optical disc 1 is rotated at a predetermined rotating speed by a spindle motor 2 for supporting the light disc 1.

Thereafter, a light beam is emitted from the light source 3 of a semiconductor laser, the light beam is condensed on the optical disc 1 by an objective lens 4, the objective lens 4 is driven by a tracking actuator and a focus actuator (not shown) for supporting the objective lens 4, and thereby the tracking servo and focus servo of the light beam condensed on optical disc 1 are applied to perform information recording on the optical disc 1 and information reproduction from the optical disc 1.

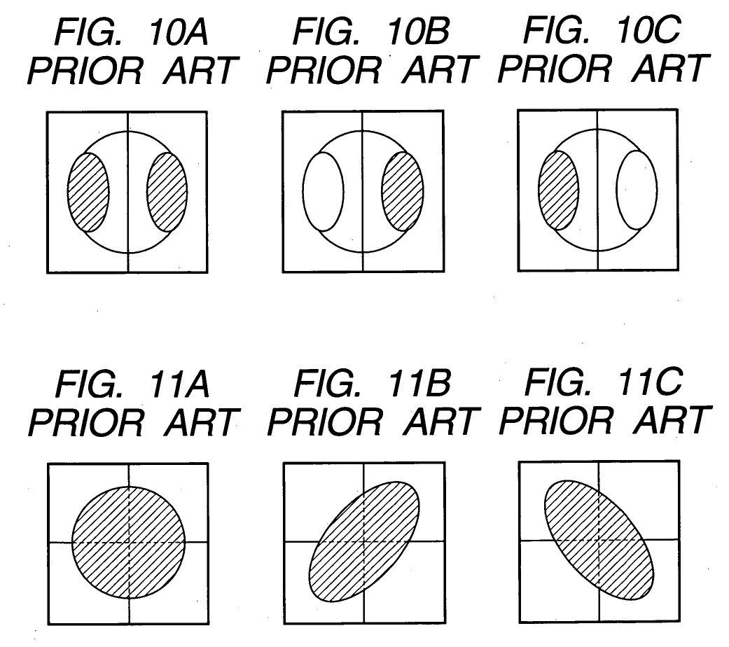

The tracking servo by the half-split sensor 5 and the focus servo by the four-split sensor 7 of the optical disc 1 in this embodiment are the same as the case of the prior art shown in FIGS. 9, 10A to 10C and 11A to 11C, and therefore description thereof is omitted.

Then, the half-split sensor 11 is provided with concentrically half-splitting it centering around the optical axis of the light beam reflected from the optical disc 1 so as to detect the light quantities of the central portion and peripheral portion of the light beam.

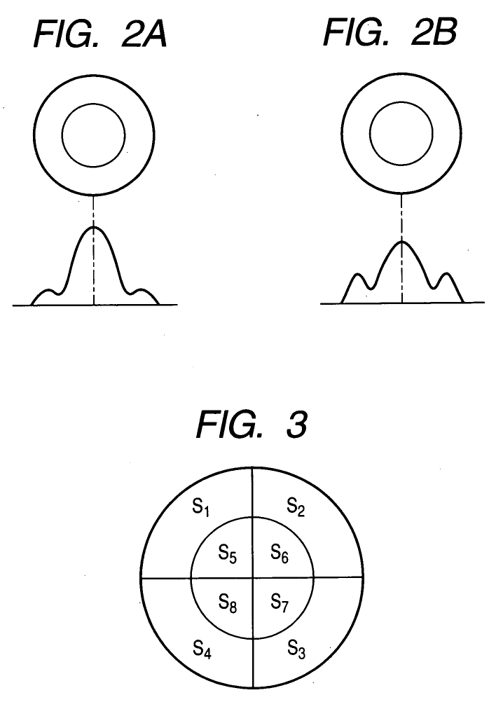

FIGS. 2A and 2B are illustrations showing detection states of a spherical aberration signal by a half-split sensor.

The intensity of incident light is shown at the lower portions of FIGS. 2A and 2B.

The state shown in FIG. 2A is a state in which a light beam is condensed at an accurate spherical aberration by the objective lens 4 on the recording/reproduction layer formed on the optical disc 1. In this case, the light beam reflected from the optical disc 1 enters each region serving as a light-receiving element of the half-split sensor 11 at a predetermined intensity ratio, and outputs Sa₁ and Sa₂ corresponding the regions become a predetermined ratio state.

The state shown in FIG. 2B is a state in which the substrate thickness of the optical disc 1 is deviated from a predetermined thickness. FIG. 2B shows a case of an unbalanced state in which the peripheral intensity of the light beam reflected from the optical disc 1 becomes larger than that at the stationary time, and outputs Sa₁ and Sa₂ are deviated from the predetermined ratio. Sa₁ and Sa₂ of the half-split sensor 11 do not become the predetermined ratio because the substrate thickness of the optical disc 1 is deviated from the predetermined thickness, the optical axis center and peripheral portion of the light beam are condensed in different focal depths (focal positions) and the so-called spherical aberration, in which intensity unevenness occurs in the light beam, occurs.

Moreover, when there is a local scratch due to a finger print on the optical disc 1 to which a light beam is condensed, a spherical aberration occurs in which the intensity of the optical axis center of the light beam and its peripheral portion do not become a predetermined ratio. Furthermore, when using a multilayer disc formed of a plurality of recording/reproduction layers for the optical disc 1, the spherical aberration occurs even when the light beam is condensed on a recording/reproduction layer different from a predetermined recording/reproduction layer.

Thus, the light beam reflected from the optical disc 1 is detected by the half-split sensor 11 which is concentrically split around the optical axis center, outputs Sa₁ and Sa₂ of the half-split sensor are adjusted so that they becomes a predetermined ratio by gain circuits 12 and 13 (G₁ and G₂ are gain constants), and the difference signal (spherical aberration error signal) S_{E} of the gain circuits 12 and 13 is computed by a difference circuit 14. When the central portion and peripheral portion of the light beam are respectively condensed in a correct focal depth (focal position) on the optical disc 1, the spherical aberration error signal becomes a desired level. When there is local substrate thickness unevenness or scratch on the optical disc 1, the spherical aberration error signal is deviated from the desired level and an error signal is generated.

Moreover, spherical aberration correcting mechanism 15 set between the light source 3 and the objective lens 4 can correct the spherical aberration of a light beam condensed to a recording/reproduction layer formed on the optical disc 1 by servo-controlling a spherical aberration correcting lens 15 formed of a pair of convexoconcave lens groups in accordance with the spherical aberration error signal. Specifically, the spherical aberration error signal S_{E} is inputted to a CPU 16 and it is discriminated whether the signal level of the spherical aberration error signal S_{E} is kept in a correct range. When the signal level of the spherical aberration error signal SE is out of the correct range, the spherical aberration is corrected by outputting a motor driving pulse from the CPU 16 to a stepping motor driver 17 and a stepping motor 18, and adjusting the distance between a pair of convexoconcave lens groups constituting the spherical aberration correcting lens 15 in the optical axis direction.

The half-split sensor 11 and four-split sensor 7 can be used in common and FIG. 3 shows an example thereof.

Because a focus error signal necessary for the focus servo is obtained by a difference signal of a sensor located on an opposite angle, the focus error signal becomes (S₁+S₃+S₅+S₇)−(S₂+S₄+S₆+S₈). Similarly, a spherical aberration signal is obtained from (S₁+S₂+S₃+S₄)−(S₅+S₆+S₇+S₈). Moreover, the four-split sensor can be used in common with the half-split sensor 5 and a tracking error signal necessary for the tracking servo is obtained from a difference signal to be divided in parallel with a track. Therefore, the tracking error signal becomes (S₁+S₄+S₅+S₈)−(S₂+S₃+S₆+S₇).

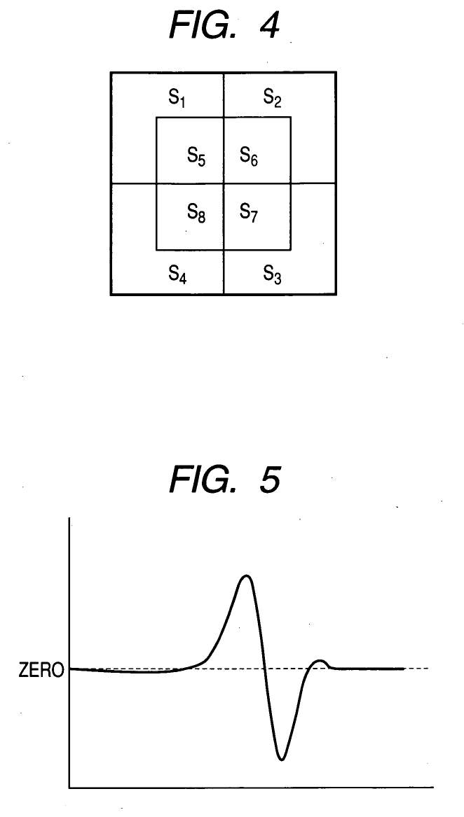

Furthermore, as another sensor, in place of a sensor concentrically divided around the optical axis of a light beam, a sensor divided into quadrangles at the optical axis as shown in FIG. 4 may be used.

Then, specific operations of an optical recording/reproduction apparatus of the present invention are described below.

When the optical disc 1 is rotated by the spindle motor 2, a light beam is emitted from the light source 3. The light beam is condensed to a recording/reproduction layer formed on the optical disc 1 by the objective lens 4 and a part of the beam is reflected from the recording/reproduction layer and enters the four-split sensor 7. In this case, when the objective lens 4 is driven by a focus actuator and a focus control circuit (not shown), whereby the focus error signal shown in FIG. 5 is obtained. In the case of the focus error signal, a portion becoming zero cross is the focal position of a predetermined recording/reproduction layer and a focus servo loop is closed at the portion where the focus error signal becomes zero cross and thereby, a light beam is condensed to and follows the recording/reproduction layer.

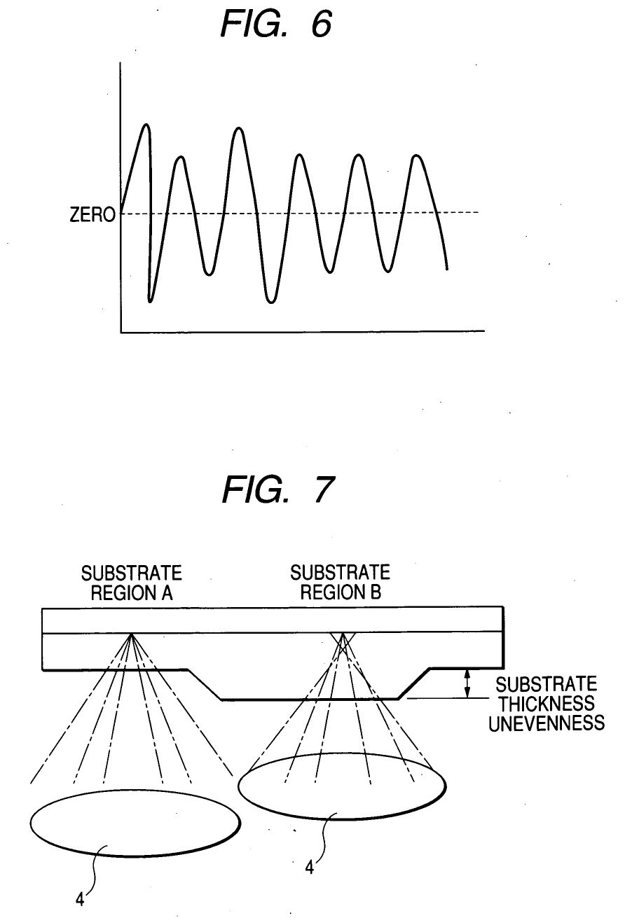

Then, a tracking error signal is obtained from the half-split sensor 5 shown in FIG. 6. A portion becoming zero cross in the tracking error signal is the central position of a recording/reproduction track provided on the recording/reproducing layer. When a tracking servo loop is closed at the portion where the tracking error signal becomes zero cross, a light beam is condensed to and follows the recording/reproduction track of the recording/reproduction layer.

Then, the balance between the central portion and peripheral portion of the light beam condensed on a recording/reproduction layer of the optical disc 1 is detected as the spherical aberration error signal S_{E} by multiplying outputs Sa₁ and Sa₂ of the half-split sensor 11 by a constant ratio from the gain circuits 12 and 13.

FIG. 7 is an illustration showing occurrence of a spherical aberration error.

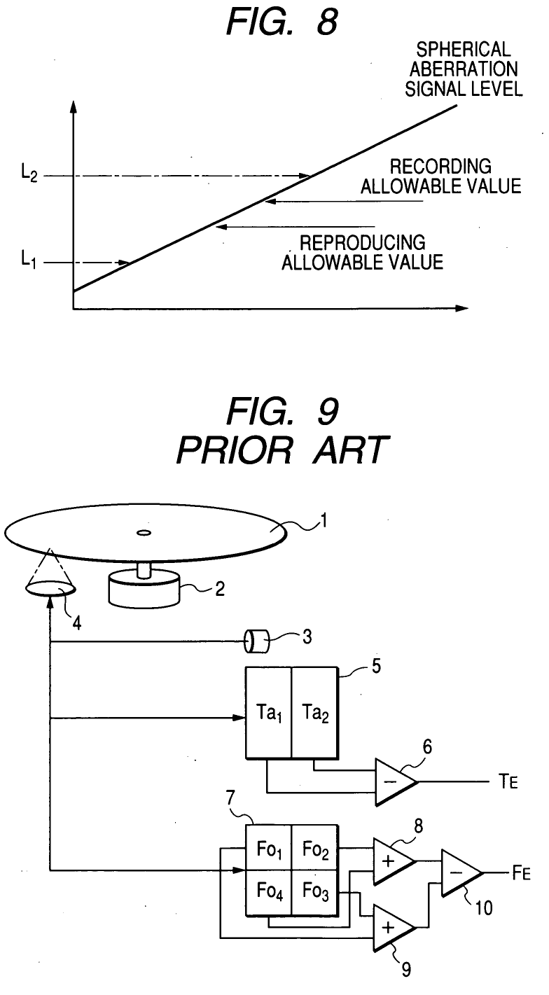

FIG. 8 is an illustration showing the level of a spherical aberration error signal.

In this case, when the light beam is condensed to a recording/reproduction layer on a substrate region A having no substrate thickness unevenness shown in FIG. 7 and the level of the spherical aberration error signal is kept in the state of a level L₁, a case is described below in which focus servo and tracking servo of a light beam are accurately performed on the optical disc 1 and information is reproduced from the optical disc 1.

First, the reproduction operation is started from a recording/reproduction layer through a predetermined substrate thickness of the optical disc 1. When an impact is added to an optical recording/reproduction apparatus including the optical disc 1 and objective lens 4 during the reproduction operation, the spherical aberration correcting lens 15 provided between the light source 3 and the objective lens 4 causes a displacement from a position corresponding to the present correction amount.

When the spherical aberration correcting lens 15 moves from the position corresponding to the present correction amount, a spherical aberration occurs on a light beam condensed to a recording/reproduction layer on the optical disc 1 because spherical aberration correction is not correctly performed by the spherical aberration correcting lens 15, and for example, a level L₂ is obtained from the half-split sensor 11 as the spherical aberration error signal S_{E} including an error in the already-known level L₁ on a first recording/reproduction layer. The CPU 16 receiving the spherical aberration error signal S_{E} outputs a motor driving pulse to the stepping motor driver 17 and stepping motor 18 to thereby perform servo control so as to decrease the distance between a pair of convexoconcave lens groups constituting the spherical aberration correcting lens 15. However, because the spherical aberration correcting lens 15 is driven by the stepping motor 18, when deterioration of the spherical aberration is drastic, servo control cannot follow the change of the spherical aberration and it is difficult to accurately reproduce information from the optical disc 1 by using the light beam. Therefore, it is discriminated by the CPU 16 whether the error level of the spherical aberration error signal S_{E} is kept in an error within a predetermined amount, that is, reproduction allowable value shown in FIG. 8. As described above, when it is discriminated that the level L₂ is detected by the half-split sensor 11 but the error of the spherical aberration error signal S_{E} is not allowed by the CPU 16, the servo control of the above-described spherical aberration correcting lens 15 and the reproduction operation are immediately stopped.

Moreover, as shown in FIG. 7, a case is described in which sharp substrate thickness unevenness is present on a part of the optical disc 1. First, when it is assumed that a light beam is condensed to a recording/reproduction layer on the substrate region A having no substrate thickness unevenness as shown in FIG. 7, because the light beam is condensed to the recording/reproduction layer through the already-known substrate thickness, the spherical aberration error signal S_{E} becomes the level L₁ and it is recognized by the CPU 16 that the central portion and peripheral portion of the light beam are condensed on the recording/reproduction layer at a normal intensity balance. However, when the light beam is condensed to the recording/reproduction layer on the substrate region B having substrate thickness unevenness as shown in FIG. 7, because the light beam is condensed to the recording/reproduction layer through a substrate thickness different from the already-known substrate thickness, a spherical aberration occurs due to different focal depths at the central portion and peripheral portion of the light beam. The spherical aberration error signal S_{E} obtained in this case includes an error signal in accordance with the size of substrate thickness unevenness, and for example, it becomes the level L₂ different from the level L₁.

Also in this case, the above-described servo-control is performed for the spherical aberration correcting lens 15 so as to move it in the direction in which a spherical aberration is corrected in accordance with the spherical aberration error signal S_{E}. However, in the case of sharp substrate thickness unevenness which the servo control cannot follow, the spherical aberration cannot be corrected and it is difficult to accurately reproduce information from the optical disc 1 by using the light beam. Therefore, it is discriminated by the CPU 16 whether the error level of the spherical aberration error signal S_{E} is an error within the reproduction allowable value shown in FIG. 8. As described above, when the level L₂ is detected by the half-split sensor 11, it is discriminated by the CPU 16 that the error of the spherical aberration error signal S_{E} is not allowed and the servo control of the spherical aberration lens 15 and the reproduction operation are immediately stopped.

As another case, the CPU 16 discriminates that the error of the spherical aberration error signal S_{E} is increased due to an impact on the above-described optical recording/reproducing apparatus or sharp substrate thickness unevenness at a part of the optical disc 1, the reproduction operation is interrupted, and automatically the reproducing operation is restarted after the spherical aberration of the light beam is corrected within an allowable range by the above-described servo control of the spherical aberration correcting lens 15 so that the error of the spherical aberration error signal S_{E} is kept within the reproduction allowable range.

Similarly, also when there is a scratch due to a finger print on the optical disc 1, it is possible to detect sudden deterioration of the spherical aberration of a light beam condensed on the optical disc 1 to stop or interrupt the reproduction operation or restart the reproduction operation.

Then, for example, when the light beam is condensed to a recording/reproduction layer on the substrate region A having no substrate thickness unevenness shown in FIG. 7 and the level of the spherical aberration error signal is kept at the level L₁, a case is described below in which focus servo and tracking servo are accurately applied to the light beam on the optical disc 1 and information is recorded from the optical disc 1.

First, the recording operation is started from a recording/reproduction layer through a predetermined substrate thickness of the optical disc 1. When an impact is added to an optical recording/reproduction apparatus including the optical disc 1 and objective lens 4 during the recording operation, the spherical aberration correcting lens 15 provided between the light source 3 and the objective lens 4 causes a displacement from a position corresponding to the present correction amount.

When the spherical aberration correcting lens 15 moves from the position corresponding to the present correction amount, spherical aberration correction by the spherical aberration correcting lens 15 is not correctly performed. Therefore, a spherical aberration occurs in a light beam condensed to a recording/reproduction layer on the optical disc 1, for example, the level L₂ is obtained as the spherical aberration error signal S_{E} including an error in the already-known level L₁ in the first recording/reproduction layer from the above-described half-split sensor 11. By receiving the spherical aberration error signal S_{E}, the CPU 16 outputs a motor driving pulse to the stepping motor driver 17 and stepping motor 18, and thereby performs servo control so as to decrease the distance between a pair of convexoconcave lens groups constituting the spherical aberration correcting lens 15. However, because the spherical aberration correcting lens 15 is driven by the stepping motor 18 and deterioration of the spherical aberration is sudden, the servo control cannot follow the change of the spherical aberration and it is difficult to accurately record information on the optical disc 1 by using the light beam. Therefore, it is discriminated by the CPU 16 whether the error level of the spherical aberration error signal S_{E} is kept as an error within a predetermined value, that is, a recording allowable value as shown in FIG. 8. As described above, when the level L₂ is detected by the half-split sensor 11 and it is discriminated by the CPU 16 that the error of the spherical aberration error signal S_{E} is not allowed, the servo control of the spherical aberration correcting lens 15 and the recording operation are stopped.

Moreover, as shown in FIG. 7, a case is described in which sharp substrate thickness unevenness is present at a part of the optical disc 1. First, when it is assumed that a light beam is condensed to a recording/reproduction layer on the substrate region A having no substrate thickness unevenness shown in FIG. 7, the light beam is condensed to the recording/reproduction layer through an already-known substrate thickness. Therefore, the level of the spherical aberration error signal becomes the level L₁ and it is recognized by the CPU 16 that the central portion and peripheral portion of the light beam are condensed on the recording/reproduction layer at a correct intensity balance. However, when the light beam is condensed to a recording/reproduction layer on the substrate region B having the substrate thickness unevenness shown in FIG. 7, the light beam is condensed to the recording/reproduction layer through a substrate thickness different from the already-known substrate thickness. Therefore, a spherical aberration occurs due to different focal depths at the central portion and peripheral portion of the light beam. The spherical aberration error signal S_{E} obtained in this case includes an error signal corresponding to the size of the substrate thickness unevenness and becomes, for example, the level L₂ different from the level L₁.

Also in this case, the spherical aberration correcting lens 15 is servo-controlled as described above so as to move in the direction in which a spherical aberration is corrected in accordance with the spherical aberration error signal S_{E}. However, in the case of sharp substrate thickness unevenness which the servo control cannot follow, the spherical aberration cannot be corrected and it is difficult to accurately record information on the optical disc 1 by using the light beam. Therefore, as shown in FIG. 8, it is discriminated by the CPU 16 whether the error level of the spherical aberration error signal S_{E} is an error within a recording allowable value. It is discriminated by the CPU that the error of the spherical aberration error signal S_{E} is not allowed and the servo control of the spherical aberration correcting lens 15 and the recording operation are immediately stopped.

Moreover, as another case, the CPU 16 discriminates that the error of the spherical aberration error signal S_{E} becomes large due to an impact on the above optical recording/reproduction apparatus or sharp substrate thickness unevenness at a part of the optical disc 1, the above recording operation is interrupted, and automatically the recording operation is restarted after the spherical aberration of the light beam is corrected within an allowable range by the above-described servo-controlling the spherical aberration correcting lens 15 so that the error of the spherical aberration error signal S_{E} is kept within a recording allowable range.

Also when there is a scratch due to a finger print on the optical disc 1, it is possible to detect sudden deterioration of the spherical aberration of a light beam condensed on the optical disc 1 and stop or interrupt and restart the recording operation.

Furthermore, it is allowed to detect that the error of the spherical aberration error signal S_{E} becomes large, stop the recording operation and, process the region of the optical disc 1 where the error of the spherical aberration error signal occur as a defect region where recording is prohibited hereinafter.

In this case, reproduction of information from the optical disc 1 is performed in accordance with the optical function of a light beam. However, recording of information on the optical disc 1 is performed in accordance with a local heating function by the light beam. Therefore, it is possible to increase the allowance for deterioration of the spherical aberration of the light beam at the time of recording in comparison with the case of reproduction, and it is also possible to individually set the allowable range of the spherical aberration error signal S_{E} as a reproduction allowable range or recording allowable value as shown in FIG. 8. Moreover, at the time of recording, it is allowed to increase the range of the recording allowable value to infinity, that is, tolerate all spherical aberration errors S_{E}. Thus, it is possible to prevent a hiatus of information recording.

Moreover, when the CPU 16 recognizes that the error of the spherical aberration error signal S_{E} becomes large at the time of recording of information in the optical disc 1 and stops or interrupts the recording operation of information on the optical disc 1, the information to be recorded on the optical disc 1 is temporarily stored in auxiliary storage means such as a semiconductor memory (not shown). In this case, when correction of the spherical aberration of a light beam condensed on the optical disc 1 requires a lot of time or the CPU 16 frequently detects deterioration of the spherical aberration and correct the spherical aberration, the information to be recorded on the optical disc 1 cannot be stored in the auxiliary storage means for temporarily storing the information to be recorded on the optical disc 1 and therefore the information to be recorded cannot be recorded on the optical disc 1 in some cases.

Therefore, it is also allowed to entirely tolerate deterioration of the spherical aberration of a light beam condensed on the optical disc 1 at the time of recording. Moreover, it is allowed to stepwise set the allowance level of the spherical aberration error signal S_{E} in accordance with the empty area of auxiliary storage means such as the semiconductor memory. Thus, it is possible to prevent a hiatus of information recording.

Furthermore, it is possible to skip a specific region of the optical disc 1 in which a spherical aberration is deteriorated due to a local substrate thickness unevenness or a scratch of the optical disc 1 as an unused region or use-prohibiting region by detecting the deterioration level of the spherical aberration of a light beam condensed on the optical disc 1 by the spherical aberration error signal.

This application claims priority from Japanese Patent Application No. 2004-056269 filed Mar. 1, 2004, which is hereby incorporated by reference herein.

1. An optical recording/reproduction apparatus for condensing a light beam on a recording/reproduction layer of an optical recording/reproduction medium, and recording or reproducing information, comprising:
a correction mechanism for correcting a spherical aberration of the light beam condensed on the medium;
a detection circuit for detecting an amount of the spherical aberration;
a discrimination circuit for discriminating whether the detected spherical aberration amount exceeds a predetermined amount; and
a stopping circuit for stopping an operation of recording or reproduction of the information when the determination circuit discriminates that the spherical aberration amount exceeds the predetermined amount.

2. The optical recording/reproduction apparatus according to claim 1, further comprising a circuit for correcting the spherical aberration of the light beam by the spherical aberration correcting mechanism after stopping the operation of recording or reproduction, and restarting the operation of recording or reproduction of the information.

3. The optical recording/reproduction apparatus according to claim 1, wherein the detection circuit for detecting the spherical aberration comprises:
a sensor for detecting the light beam reflected from or passing through the medium by a plurality of light-receiving elements, and
a circuit for computing the spherical aberration amount of the light beam condensed on the medium in accordance with an output signal of the sensor.

4. The optical recording/reproduction apparatus according to claim 1, wherein the predetermined amount is set to a different value in accordance with the operation of recording or reproduction.

5. The optical recording/reproduction apparatus according to claim 4, wherein the predetermined amount in the operation of recording is set to a value higher than the predetermined amount in the operation of reproduction.

6. The optical recording/reproduction apparatus according to claim 1, wherein the predetermined value is set to a stepwise value in accordance with an empty area of a buffer memory for storing a recording signal.

7. The optical recording and reproducing apparatus according to claim 3, wherein the plurality of light-receiving elements of the sensor are arranged concentrically to an optical axis of the light beam.

8. An optical recording/reproduction method for condensing a light beam on a recording/reproduction layer of an optical recording/reproduction medium, and recording or reproducing information, comprising:
a step of correcting a spherical aberration of the light beam condensed on the medium;
a step of detecting an amount of the spherical aberration;
a step of discriminating whether the detected spherical aberration amount exceeds a predetermined amount; and
a step of stopping an operation of recording or reproduction of the information when it is discriminated that the spherical aberration amount exceeds the predetermined amount.
